(19) United States
(12) Patent Application Publication
(10) Pub. No.: US 2024/0220247 A1
(43) Pub. Date: Jul. 4, 2024

(54) Permute Instructions for Register-Based Lookups

(71) Applicant: Advanced Micro Devices, Inc., Santa Clara, CA (US)

(72) Inventors: Vadim Vadimovich Nikiforov, Berkeley, CA (US); Yasuko Eckert, Redmond, WA (US); Bradford Michael Beckmann, Kirkland, WA (US)

(73) Assignee: Advanced Micro Devices, Inc., Santa Clara, CA (US)

(21) Appl. No.: 18/148,873

(22) Filed: Dec. 30, 2022

(51) Int. Cl. G06F 9/30

(52) U.S. Cl. CPC G06F 9/30127; G06F 9/30134

(57) ABSTRACT

Permute instructions for register-based lookups is described. In accordance with the described techniques, a processor is configured to perform a register-based lookup by retrieving a first result from a first lookup table based on a subset of bits included in an index of a destination register, retrieving a second result from a second lookup table based on the subset of bits included in the index of the destination register, selecting the first result or the second result based on a bit in the index of the destination register that is excluded from the subset of bits, and overwriting data included in the index of the destination register using a selected one of the first result or the second result.

### BACKGROUND

Computing systems employ lookup tables as one technique to reduce the overhead of expensive computations. Lookup tables are commonly stored in memory and accessed through a cache. However, some permutation instructions support implementing register-based lookup tables. In some examples, the register-based lookup tables are located within a processor core, enabling direct access by the processor core (e.g., avoiding memory access via the cache). As a result, permutations instructions that utilize register-based lookup tables have higher throughput, increased performance determinism, and reduced usage of cache bandwidth compared with utilizing memory-based lookup tables. Thus, computing systems that utilize register-based lookup tables result in increased computer performance while reducing data transfer latency as compared to conventional memory-based lookup tables.

### BRIEF DESCRIPTION OF THE DRAWINGS

The detailed description is described with reference to the accompanying figures.

FIG. 1 is a block diagram of a non-limiting example system configured to employ permute instructions for register-based lookups.

FIG. 2 shows data paths of a non-limiting example implementation of performing a byte-level permutation using register-based lookups.

FIGS. 3A and 3B show data paths of a non-limiting example implementation of performing an 8-bit input, 8-bit output register-based lookup.

FIG. 4 shows data paths of a non-limiting example implementation performing an 8-bit input, 4-bit output register-based lookup.

FIG. 5 depicts a procedure in an example implementation of executing instructions by a processor to perform a register-based lookup.

FIG. 6 depicts a procedure in an example implementation of operations performed in a data storage component while executing a register-based lookup.

FIG. 7 depicts a procedure 700 in an example implementation of operations performed in a data storage component while executing a packed 4-bit permute instruction.

### DETAILED DESCRIPTION

### Overview

Some compute-intensive workloads, especially workloads involving intense bit manipulations, benefit from hardware support for computations to increase performance. Examples of such compute-intensive workloads include cryptography/cryptanalysis, string manipulation and optimization, genomic data sequencing and analysis, and so forth. In some implementations, hardware support for such compute-intensive workloads is achieved using register-based lookups. One approach for performing a register-based lookup includes performing a byte-level permutation. In one implementation of performing a byte-level permutation, indices are stored in a destination register, and the indices are used to index into two source registers. In an example implementation where each destination register index includes eight bits of data and the instruction uses 512-bit registers, index bits are described as bits [7:0], where bit seven represents a leftmost bit of the index and bit zero represents a rightmost bit of the index. Bit six of each destination register index identifies which of the two source registers includes the data to be looked-up, and bits [5:0] identify a byte position within the identified source register. The index of the destination register that was used to identify which source register is used for data lookup, as well as where within the source register lookup data is located, is then overwritten with the result of the lookup.

In this approach, bit seven (e.g., a leftmost bit) of a destination register index is unused by the byte-level permutation instructions. That is, seven bits of data from a destination register index are used to identify eight bits of data from a source register, and the identified eight bits of data are subsequently used to overwrite the eight bits of data in the destination register index. Implementing lookups with wider inputs (e.g., more than seven bits of data, such as eight bits of data) using this approach entails double the registers and lookup instructions for every additional bit of input. For example, seven bits of data are useable to uniquely identify one of 128 entries stored in two source registers based on a combination of values (e.g., ones and zeroes) stored in the seven bits of data, while eight bits of data are useable to uniquely identify one of 256 entries stored in four source registers based on the combination of values stored in the eight bits of data. However, each lookup operation is constrained to two source registers. Therefore, two lookup operations are performed for eight bits of input, including a first lookup operation that retrieves data from a first pair of source registers and a second lookup operation that retrieves data from a second pair of source registers.

Because two results are retrieved when the byte-level permutation instructions are executed with eight bits of input data from the destination register index, one to two mask registers are generated and used for every lookup performed in order to select which of the two results to overwrite into each destination register index. Each mask register defines which destination register indices will be overwritten with the result of a given lookup operation (e.g., by setting a corresponding mask register bit to 1) and which will be unchanged (e.g., by setting a corresponding mask register bit to 0) in order to combine results from both lookup operations. Each mask register is generated based on the value of bit seven. For example, executing a first mask instruction generates first mask register that applies a mask to destination register indices having a bit seven value of one, and executing the second mask instruction generates a second mask register that applies a mask to destination register indices having a bit seven value of zero. Thus, a given destination register index that is masked by the first mask register is not masked by the second mask register, and vice versa. The first mask register is used to selectively overwrite the destination register indices with results from the first lookup operation, and the second mask register is used to selectively overwrite the destination register with results from the second lookup operation. However, these mask instructions increase overhead and decrease a processing efficiency.

To overcome these problems, permute instructions for register-based lookups are described. In accordance with the described techniques, the permute instructions utilize all eight bits of data stored in a destination register index as input in order to access source registers without requiring additional mask instructions or mask registers, as required by previous approaches. In one or more implementations, two lookups are performed to retrieve results from four source registers, where bit seven of a destination register index functions as a mask to identify whether the destination register index will be overwritten with the result of a given lookup. For example, the first lookup is performed using a first instruction that looks into a first source register that includes a first lookup table and a second source register that includes a second lookup table. The second lookup is performed using a second instruction that looks into a third source register that includes a third lookup table and a fourth source register that includes a fourth lookup table. The first lookup retrieves a first result, and the second lookup retrieves a second result.

In an example scenario, the first result is written into a destination register index in response to a value of bit seven being a first value (e.g., zero), and the first result is not written into the index (e.g., a mask is applied to the index) in response to the value of bit seven being a second value (e.g., one). Continuing this example scenario, the second result is written into the index in response to the value of bit seven being the second value (e.g., one), and the second result is not written into the index (e.g., the mask is applied to the index) in response to the value of bit seven being the first value (e.g., zero). As such, the first instruction provides the result to the index when the value of bit seven is the first value (e.g., zero), and the second instruction provides the result to the index when the value of bit seven is the second value (e.g., one).

In at least one implementation, the first instruction and the second instruction both utilize a multiplexer that receives two inputs and uses the value of bit seven as a selector for which input to output (e.g., which input to use in overwriting data of a destination register that was used to locate the two inputs). As an example, during execution of the first instruction, the multiplexer receives the first result and the original value of the destination register index as inputs, then outputs either the first result in response to the value of bit seven being zero, or the original value in response to the value of bit seven being the one. During the second instruction, the multiplexer receives the second result and the original value of the destination register index as inputs, then outputs either the second result in response to the value of bit seven being one, or the original value in response to the value of bit seven being zero. Thus, the first instruction and the second instruction are executed in combination to provide an eight-bit output for an eight-bit input, without utilizing additional mask registers as required by conventional register lookup approaches and thus reducing computational overhead relative to these conventional approaches.

In another implementation, source registers store data using fewer than eight bits, such as four bits of data. The techniques described herein are extendable to these four-bit storage implementations using a packed four-bit permute instruction. In an example scenario, the packed four-bit permute instruction is executed to retrieve four-bit results from two source registers based on eight bits of input from each destination register index using a single lookup. Eight bits of data is referred to as a byte, and four bits of data is referred to as a nibble. For example, each source register defines two lookup tables, with each byte storing a high nibble result of a first lookup table in the four leftmost bits (e.g., bits [7:4]) and a low nibble result of a second lookup table in the four rightmost bits (e.g., bits [3:0]). In the packed four-bit permute instruction, both of the high nibble result and the low nibble result are retrieved during the lookup, and bit seven (e.g., the leftmost bit) of the destination register index functions to select between the high nibble result and the low nibble result for overwriting the index.

In at least one implementation, the packed 4-bit instruction utilizes the multiplexer. The multiplexer receives the high nibble result and the low nibble result as inputs and uses the value of bit seven as the selector for which input (e.g., which source register data) to output (e.g., write to the destination register). As an example, the multiplexer outputs the high nibble result in response to the value of bit seven being the first value and outputs the low nibble result in response to the value of bit seven being the second value. The output of the multiplexer is written into bits [3:0] of the index, while bits [7:4] are zeroed, at least in some implementations. Thus, the packed 4-bit instruction provides a 4-bit output for an 8-bit input.

In accordance with the techniques described herein, the number of instructions used to perform register-based lookups, including register-based lookups for at least eight bits of input, are reduced relative to other register-based lookup approaches. Furthermore, instructions to generate masks in separate mask registers are avoided for eight bits of input, thus reducing overhead (e.g., excess or indirect computations or resource usages that are used to perform a specific task). A technical effect of utilizing bit seven of an index of a destination register to selectively overwrite the index with one of a first result and a second result while executing a permute operation in a computer system is that an efficiency of the computer system is increased. For instance, extracting the value of bit seven to generate one or more mask registers using separate mask instructions, as necessitated by other register-based lookup approaches, is not required to perform the techniques described herein.

A variety of other instances are also contemplated, examples of which are described in the following discussion and shown using corresponding figures.

In some aspects, the techniques described herein relate to a system including a destination register and at least two source registers storing lookup tables, and a processor configured to perform a register-based lookup by retrieving a first result from a first lookup table based on a subset of bits included in an index of the destination register, retrieving a second result from a second lookup table based on the subset of bits included in the index of the destination register, selecting the first result or the second result based on a bit in the index of the destination register that is excluded from the subset of bits, and overwriting data included in the index of the destination register using a selected one of the first result or the second result.

In some aspects, the techniques described herein relate to a system, wherein the first lookup table and the second lookup table are included in a same source register of the at least two source registers, and wherein the processor performs the retrieving the first result from the first lookup table and the retrieving the second result from the second lookup table during a single lookup operation.

In some aspects, the techniques described herein relate to a system, wherein the index of the destination register includes a byte lane of eight bits, and wherein overwriting the data included in the index of the destination register includes overwriting the byte lane with the first result in response to the bit in the index of the destination register that is excluded from the subset of bits including a first value, or overwriting the byte lane with the second result in response to the bit in the index of the destination register that is excluded from the subset of bits including a second value.

In some aspects, the techniques described herein relate to a system, wherein selecting the first result or the second result includes inputting the first result and the second result to a multiplexer, providing the bit in the index of the destination register that is excluded from the subset of bits as a select line to the multiplexer, and causing the multiplexer to output the first result in response to the bit in the index of the destination register that is excluded from the subset of bits being a first value, or causing the multiplexer to output the second result in response to the bit in the index of the destination register that is excluded from the subset of bits being a second value.

In some aspects, the techniques described herein relate to a system, wherein the retrieving the first result from the first lookup table and retrieving the second result from the second lookup table includes retrieving the first result by executing a first instruction and retrieving the second result by executing a second instruction.

In some aspects, the techniques described herein relate to a system, wherein retrieving the first result from the first lookup table by executing the first instruction and retrieving the second result from the second lookup table by executing the second instruction includes, while executing the first instruction, selecting, as the first lookup table, a first source register or a second source register from the at least two source registers based on one of the subset of bits included in the index of the destination register, selecting a first byte lane of the selected first source register or the selected second source register based on a remainder the subset of bits included in the index of the destination register, the remainder excluding the one, and retrieving the first result from the first byte lane, and, while executing the second instruction, selecting, as the second lookup table, a third source register or a fourth source register from the at least two source registers based on the one of the subset of bits included in the index of the destination register, selecting a second byte lane of the selected third source register or the selected fourth source register based on the remainder of the subset of bits included in the index of the destination register, and retrieving the second result from the second byte lane.

In some aspects, the techniques described herein relate to a system, wherein the subset of bits included in the index of the destination register includes bits [6:0] of an eight-bit index, wherein the one of the subset of bits is bit six of the eight-bit index, and the remainder of the subset of bits include bits [5:0] of the eight-bit index.

In some aspects, the techniques described herein relate to a system, wherein the index of the destination register includes an eight-bit index, and wherein overwriting the data included in the index of the destination register using the selected one of the first result or the second result includes overwriting the data included in the index of the destination register with the first result in response to bit seven of the eight-bit index being a first value while executing the first instruction, or overwriting the data included in the index of the destination register with the second result in response to the bit seven of the eight-bit index being a second value while executing the second instruction.

In some aspects, the techniques described herein relate to a system, wherein overwriting the data included in the index of the destination register using the selected one of the first result or the second result further includes, while executing the first instruction, providing the first result and an original value of the eight-bit index as inputs to a multiplexer, providing the bit seven as a select line to the multiplexer, and receiving the first result as an output of the multiplexer in response to the bit seven being the first value, or receiving the original value as the output of the multiplexer in response to the bit seven being the second value, and, while executing the second instruction, providing the second result and the original value of the eight-bit index as inputs to the multiplexer, providing the bit seven as the select line to the multiplexer, and receiving the second result as the output of the multiplexer in response to the bit seven being the second value, or receiving the original value as the output of the multiplexer in response to the bit seven being the first value.

In some aspects, the techniques described herein relate to a system including a destination register storing indices and at least two source registers storing lookup tables and a processor configured to execute instructions to access the destination register and the at least two source registers, and for an index of the destination register, identify a byte lane of the at least two source registers based on bits [6:0] of the index of the destination register, and overwrite data included in the index of the destination register with a lookup entry defined in the identified byte lane based on a value of bit seven of the index of the destination register.

In some aspects, the techniques described herein relate to a system, further including a multiplexer positioned in a data path between the at least two source registers and the index of the destination register, the multiplexer configured to receive two inputs and a select line, and output one of the two inputs based on the select line.

In some aspects, the techniques described herein relate to a system, wherein the lookup entry includes a high nibble result and a low nibble result, and wherein the processor is configured to overwrite the data included in the index of the destination register with the high nibble result or the low nibble result based on the value of bit seven of the index of the destination register.

In some aspects, the techniques described herein relate to a system, wherein the processor is further configured to execute the instructions to provide the high nibble result to the multiplexer as a first input of the two inputs, provide the low nibble result to the multiplexer as a second input of the two inputs, provide the value of bit seven as the select line to the multiplexer, and overwrite the data included in the index of the destination register with the output of the multiplexer.

In some aspects, the techniques described herein relate to a system, wherein to overwrite the data included in the index of the destination register, the processor is further configured to execute the instructions to select the high nibble result as the output of the multiplexer in response to the value of bit seven being a first value, select the low nibble result as the output of the multiplexer in response to the value of bit seven being a second value, and overwrite four bits of the index of the destination register with the output of the multiplexer.

In some aspects, the techniques described herein relate to a system, wherein to overwrite the data included in the index of the destination register, the processor is further configured to execute the instructions to provide the lookup entry to the multiplexer as a first input of the two inputs, provide an original value of the index of the destination register to the multiplexer as a second input of the two inputs, provide the value of bit seven as the select line to the multiplexer, and overwrite the data included in the index of the destination register with an output of the multiplexer.

In some aspects, the techniques described herein relate to a system, wherein the lookup entry includes a first lookup entry retrieved while executing a first instruction of the instructions and a second lookup entry retrieved while executing a second instruction of the instructions, and wherein the processor is configured to execute the first instruction and the second instruction in combination.

In some aspects, the techniques described herein relate to a system, wherein, to overwrite the data included in the index of the destination register, the processor is further configured to execute the instructions to during the first instruction select the first lookup entry as the output of the multiplexer in response to the value of bit seven being a first value, and select the original value of the index of the destination register as the output of the multiplexer in response to the value of bit seven being a second value, and during the second instruction select the second lookup entry as the output of the multiplexer in response to the value of bit seven being the second value, and select the original value of the index of the destination register as the output of the multiplexer in response to the value of bit seven being the first value.

In some aspects, the techniques described herein relate to a system, wherein to execute the first instruction and the second instruction in combination, the processor is further configured to identify the byte lane from a first lookup pair that includes a first source register and a second source register of the at least two source registers while executing the first instruction, and identify the byte lane from a second lookup pair that includes a third source register and a fourth source register of the at least two source registers while executing the second instruction.

In some aspects, the techniques described herein relate to a method including accessing a destination register and a plurality of source registers, the destination register storing indices for retrieving a combination of entries from the plurality of source registers, and for at least one of the indices of the destination register retrieving a first entry identified by bits [6:0] of an index in the destination register from a first lookup table that is stored in the plurality of source registers, retrieving a second entry identified by the bits [6:0] of the index in the destination register from a second lookup table that is stored in the plurality of source registers, and overwriting data included in the index in the destination register with the first entry or the second entry based on a value of bit seven of the index in the destination register.

In some aspects, the techniques described herein relate to a method, further including providing the first entry and the second entry as inputs to a multiplexer and providing the value of bit seven of the index in the destination register as a select line to the multiplexer, and selecting the first entry or the second entry for overwriting the data included in the index in the destination register based on an output of the multiplexer.

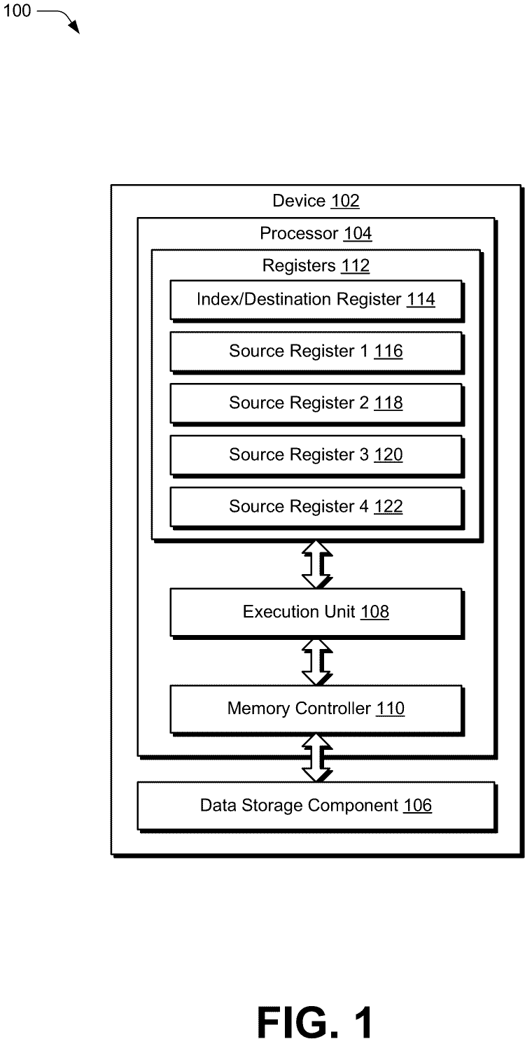

FIG. 1 is a block diagram of a non-limiting example system 100 configured to employ permute instructions for register-based lookups. The system 100 includes a device 102 having a processor 104 and a data storage component 106. The device 102 is configurable in a variety of ways. Examples of which include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. Additional examples include artificial intelligence training accelerators, cryptography and compression accelerators, network packet processors, and video coders and decoders. It is to be appreciated that in various implementations, the device 102 is configured as any one or more of those devices listed just above and/or a variety of other devices without departing from the spirit or scope of the described techniques.

The processor 104 includes an execution unit 108 (e.g., an arithmetic logic unit) and a memory controller 110. The execution unit 108 is representative of functionality of the processor 104 implemented in hardware that performs operations, e.g., based on instructions received through execution of software (e.g., an operating system, computer programs, applications, etc.). In at least one implementation, the processor 104 includes more than one core, each core including a separate execution unit 108 (e.g., the processor 104 is a multi-core processor).

The data storage component 106 is a device or system that is used to store information, such as for use in the device 102 (e.g., by the execution unit 108 of the processor 104). In one or more implementations, the data storage component 106 corresponds to semiconductor memory where data is stored within memory cells on one or more integrated circuits. Additionally or alternatively, the data storage component 106 corresponds to or includes volatile memory, examples of which include random-access memory (RAM), dynamic random-access memory (DRAM), synchronous dynamic random-access memory (SDRAM), and static random-access memory (SRAM). Alternatively or in addition, the data storage component 106 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The data storage component 106 is configurable in a variety of ways without departing from the spirit or scope of the described techniques.

The processor 104 further includes registers 112. The registers 112 are configured to maintain data that is processed by the execution unit 108 (e.g., for arithmetic and logic operations). Additionally or alternatively, the registers 112 are included in a processing-in-memory component where a processor is integrated with the data storage component 106 (e.g., with RAM).

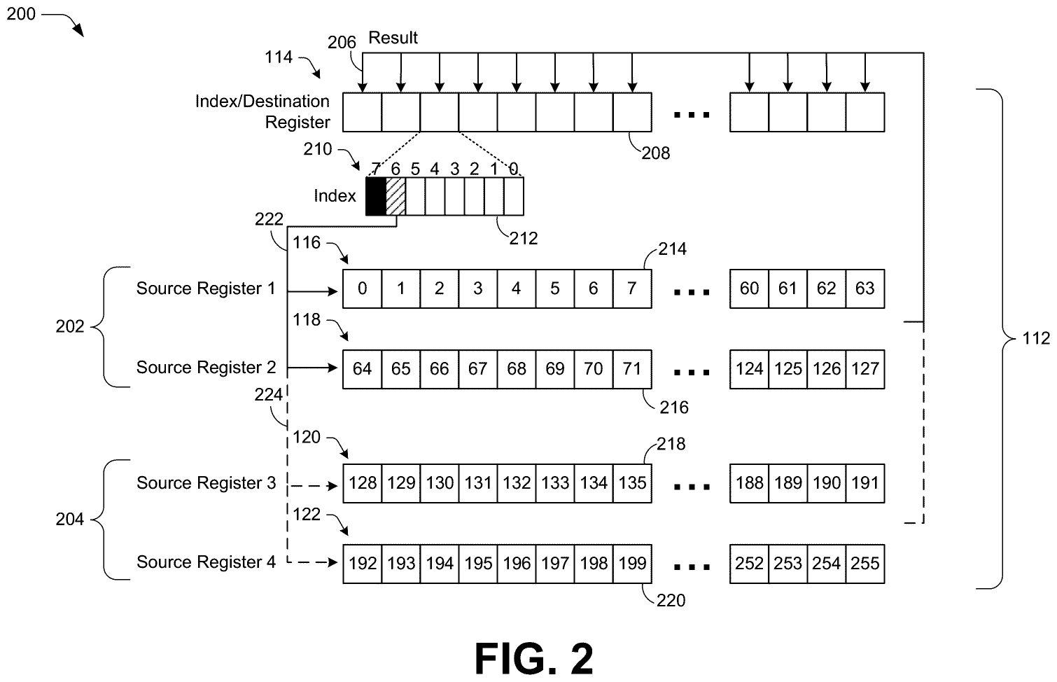

The registers 112 include an index/destination register 114 and a plurality of source registers, shown as a first source register 116 (e.g., source register 1), a second source register 118 (e.g., source register 2), a third source register 120 (e.g., source register 3), and a fourth source register 122 (e.g., source register 4). In various implementations, the registers 112 include one or more additional index/destination registers and source registers. The index/destination register 114 stores indices that are used to identify lookup entries stored in the plurality of source registers. In response to permute instructions that will be further described herein, the index/destination register 114 is overwritten with a combination of lookup entries from at least two of the plurality of source registers based on values of the indices. An example architecture of the registers 112 will be described below with respect to FIG. 2.

The memory controller 110 is representative of functionality of the processor 104 to execute instructions for managing data at the data storage component 106. In various implementations, the memory controller 110 executes instructions and corresponding operations involve writing data to the registers 112 of the execution unit 108 for processing (e.g., from one of the registers 112 to a different one of the registers 112, from a data storage component external to the processor, such as a physical volatile memory).

In at least one implementation, data is fetched from lookup tables stored in the data storage component 106 and loaded to the registers 112 in response to load instructions executed by the memory controller 110. The registers 112 store data and instructions that are currently in execution by the execution unit 108 (e.g., operands), whereas the lookup tables of the data storage component 106 store data and instructions that are accessed by the processor 104 for various program executions. As such, the registers 112 enable direct access by the execution unit 108, and the direct access increases data accessibility and processing speeds (e.g., relative to data stored in the lookup tables), although the lookup tables of the data storage component 106 have a greater storage capacity in comparison to the registers 112.

As described herein, register-based lookups (e.g., lookup operations using the registers 112) enable reduced usage of cache bandwidth, higher throughput, and increased determinism relative to memory-based lookups. Furthermore, some instructions enable bit-level permutations of the registers 112.

FIG. 2 is a block diagram of a non-limiting example implementation 200 of the registers 112. In particular, the non-limiting example implementation 200 shows data paths for performing an 8-bit input using instructions that ignore the eighth bit of input (e.g., bit seven). The index/destination register 114 includes information for performing the lookup and also receives results 206 of the lookup. The first source register 116, the second source register 118, the third source register 120, and the fourth source register 122 include entries that are written back to the index/destination register 114 as the results 206. The first source register 116 and the second source register 118 form a first lookup pair 202 of low and high entries, respectively, and the third source register 120 and the fourth source register 122 form a second lookup pair 204 of low and high entries.

The index/destination register 114 includes a plurality of byte lanes 208, only one of which is labeled in FIG. 2 for illustrative clarity. Each of the byte lanes 208 includes an index 210 of bits 212. The bits 212 are labeled numerically (e.g., 7, 6, 5, 4, 3, 2, 1, and 0 from left to right). In the non-limiting example implementation 200, the index/destination register 114 includes 64 byte lanes 208 (e.g., 512 bits). However, it is to be understood that in variations, the index/destination register 114 includes a different number of the byte lanes 208.

The first source register 116 includes byte lanes 214, the second source register 118 includes byte lanes 216, the third source register 120 includes byte lanes 218, and the fourth source register 122 includes byte lanes 220. In the non-limiting example implementation 200, the first source register 116, the second source register 118, the third source register 120, and the fourth source register 122 each include 64 bytes. The byte lanes 214 of the first source register 116 are each labeled numerically from 0 to 63, the byte lanes 216 of the second source register 118 are each labeled numerically from 64 to 127, the byte lanes 218 of the third source register 120 are each labeled numerically from 128 to 191, and the byte lanes 220 of the fourth source register 122 are each labeled numerically from 192 to 255. Thus, the non-limiting example implementation 200 includes 256 total entries in the source registers. It is to be appreciated that in various implementations, the first source register 116, the second source register 118, the third source register 120 and the fourth source register 122 include a different number of entries (e.g., more or fewer than 64 entries each).

The indices stored in the index/destination register 114 are used to index into the source registers. In various implementations, the index 210 of each byte lane 208 of the index/destination register 114 includes instructions specifying the source register to look into as well as the byte position within the selected source register. In at least one implementation, permute instructions are constrained to three operands (e.g., the index/destination register 114 and two source registers). Therefore, two lookups are performed, including a first lookup 222 (solid arrows) into the first lookup pair 202 and a second lookup 224 (dashed arrows) into the second lookup pair 204, in response to eight bits of input in order to utilize all 256 entries.

Furthermore, additional mask instructions are used to select the result 206 from the first lookup 222 or the second lookup 224 for each byte lane 208. In at least one implementation, a separate mask instruction checks bit seven values of every index 210 and writes the values into a first mask register (not shown) that is used for the first lookup. The values of the first mask register are inverted in a second mask register (not shown) that is used for the second lookup. That is, positions set to “one” in the first mask register are set to “zero” in the second mask register, and positions set to “zero” in the first mask register are set to “one” in the second mask register. The first mask register and the second mask register each function to select whether or not a given byte lane 208 of the index/destination register 114 is overwritten with the result of the corresponding lookup.

By way of example, during the first lookup 222, bit six of the index 210 is used to identify whether the first source register 116 or the second source register 118 is to be looked into. Bit six of the index 210 is set to either “zero” or “one,” with “zero” indicating the selection of one of the first source register 116 and the second source register 118, and “one” indicating the selection of the other of the first source register 116 and the second source register 118. In an example, the first source register 116 is selected when bit six of the index 210 is set to “zero,” and the second source register 118 is selected when bit six of the index 210 is set to “one.” Bits [5:0] of the index 210 are used to identify the byte lane within the selected source register. In at least one variation, the byte lanes 208 of the index/destination register 114 are overwritten with the result 206 from the identified byte lane of the selected source register when a corresponding lane of the first mask register is set to “zero” and not when the corresponding lane of the first mask register is set to “one.” For example, when the first source register 116 is selected based the value of bit six of the index 210, the corresponding byte lane 208 is overwritten with the result 206 from the byte lane 214 that is uniquely identified using the values in bits [5:0] of the index 210 when no mask is applied by the first mask register. Similarly, when the second source register 118 is selected based on the value of bit six of the index 210 and the corresponding lane of the first mask register is set to “zero,” the corresponding byte lane 208 is overwritten with the result 206 from the byte lane 216 that is uniquely identified using bits [5:0] of the index 210.

Continuing the above example, during the second lookup 224, bit six of the index 210 is used to identify whether the third source register 120 or the fourth source register 122 is to be looked into, and bits [5:0] of the index 210 are used to specify the byte lane within the selected source register. The byte lanes 208 of the index/destination register 114 are overwritten with the result 206 from the identified byte lane of the selected source register when enabled by the second mask register (e.g., when a corresponding lane of the second mask register is set to “zero”). For example, when the third source register 120 is selected based on the value of bit 6 of the index 210 and the corresponding lane of the second mask register is set to “zero,” the corresponding byte lane 208 is overwritten with the result 206 from the byte lane 218 that is uniquely identified using bits [5:0] of the index 210. Similarly, when the fourth source register 122 is selected based on the value of bit six of the index 210 and the corresponding lane of the second mask register is set to “zero,” the corresponding byte lane 208 is overwritten with the result 206 from the byte lane 220 that is uniquely identified using bits [5:0] of the index 210.

As a result of the two lookups in combination with the first mask register and the second mask register, the index/destination register 114 is overwritten with the result 206 from a combination of the first source register 116, the second source register 118, the third source register 120, and the fourth source register 122. It is to be appreciated that bit seven (e.g., the eighth bit 212 of the index 210) is unused by the permute instruction in the non-limiting example implementation 200. As such, lookups with input sizes greater than seven bits are inefficient to implement due to the high overhead used for the computation of masks for the extra input bits (e.g., those exceeding seven bits). When greater than seven bits of input are used, most instructions used to perform a hierarchical lookup are overhead instructions used to generate masks, including the first mask register and the second mask register. As used herein, “overhead” refers to any combination of excess or indirect computations or resource usages that are used to perform a specific task (e.g., the register-based lookup). For example, at least one mask instruction is used for every lookup performed when greater than seven bits of input are used.

Thus, in accordance with the techniques described herein, permute instructions that use all eight bits of the index 210 are employed to reduce the number instructions used to perform register-based lookups and increase performance and computational efficiency.

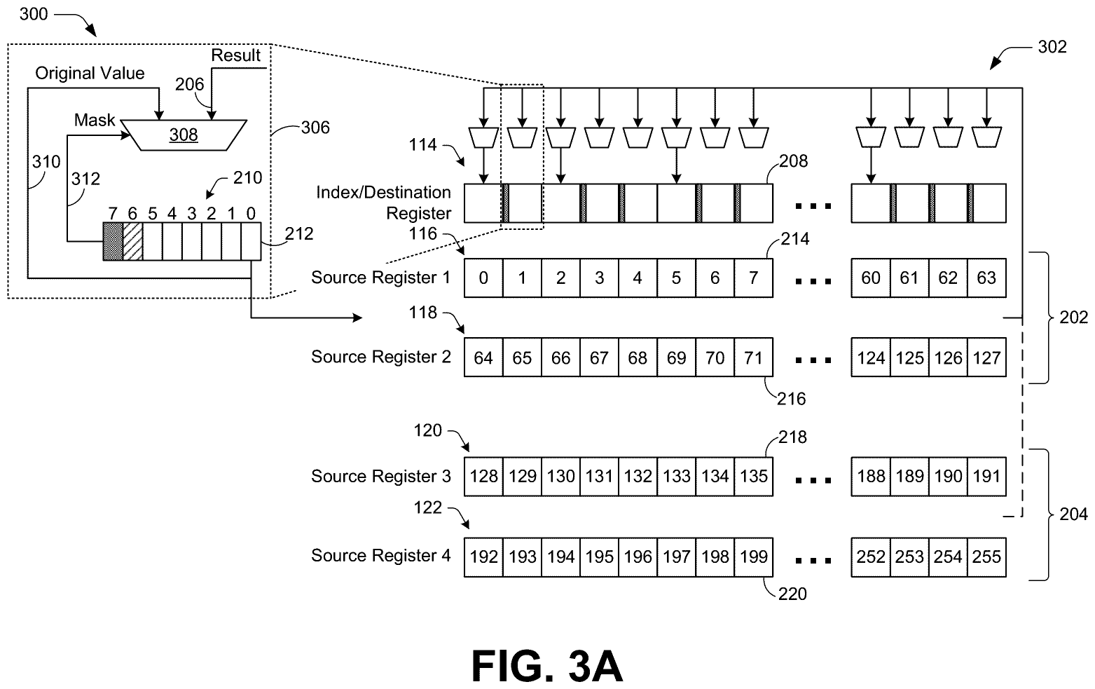

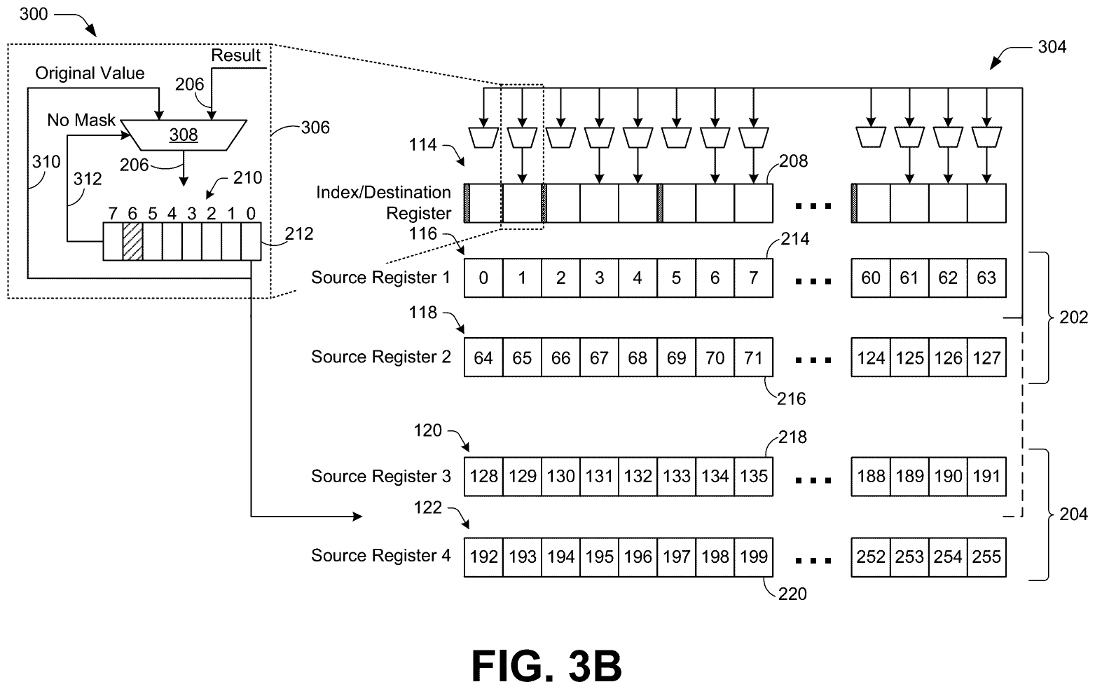

FIGS. 3A and 3B show a non-limiting example implementation 300 of an 8-bit input, 8-bit output register-based lookup that is performed via instructions that employ automatic masking. In particular, FIG. 3A schematically shows a data path for executing a first instruction 302 of the non-limiting example implementation 300, and FIG. 3B schematically shows a data path for executing a second instruction 304 of the non-limiting example implementation 300. The non-limiting example implementation 300 includes performing a lookup into four register tables. As will be elaborated below, the first instruction 302 is executed to perform the lookup into the first lookup pair 202, and the second instruction 304 is executed to perform the lookup into the second lookup pair 204. In at least one implementation, the first instruction 302 and the second instruction 304 are combined by a compiler and executed in combination (e.g., in sequence, such as back-to-back, or in parallel) in order to look into the four register tables (e.g., the first source register 116, the second source register 118, the third source register 120 and the fourth source register 122). The results are written to the index/destination register 114 after both of the first instruction 302 and the second instruction 304 are executed, at least in one variation.

FIGS. 3A and 3B both include an inset 306 showing the index 210 of a single byte lane 208 of the index/destination register 114 and a multiplexer 308. In at least one implementation, the multiplexer 308 is hardware component that functions as a data selector for two inputs. As will be elaborated herein, the multiplexer 308 selects between the result 206 of the lookup and an original value 310 of the byte lane 208 based on a bit seven value 312 of the index 210. As such, in various implementations, the bit seven value 312 is used as a mask to determine if a particular byte lane 208 of the index/destination register 114 is overwritten by the result 206 of each lookup.

Referring first to FIG. 3A, the first instruction 302, also termed a “low instruction” herein, is executed (e.g., by the processor 104) to perform a lookup into the first lookup pair 202. Bit six of the index 210 is used to select either the first source register 116 or the second source register 118, and bits [5:0] of the index 210 are used to identify the byte lane within the selected source register, such as described herein. However, instead of generating and using a separate mask register, in various implementations, the first instruction 302 uses the bit seven value 312 to select between the result 206 and the original value 310.

In at least one implementation, the bit seven value 312 functions as a selector line for the multiplexer 308 according to the first instruction 302. For example, the first instruction 302 instructs the multiplexer 308 to overwrite the corresponding byte lane 208 of the index/destination register 114 with the result 206 of the lookup when the bit seven value 312 is “zero” and to keep the original value 310 when the bit seven value 312 is “one.”

By way of example, the inset 306 depicts the bit seven value 312 applying a mask so that the corresponding byte lane 208 keeps the original value 310 and is not overwritten by the result 206. That is, the bit seven value 312 is “one,” and so, per the first instruction 302, the multiplexer 308 selects the original value 310. As such, the bit seven value 312 functions as a mask to either keep or overwrite the corresponding byte lane 208 of the index/destination register 114 with the result 206.

Referring now to FIG. 3B, the second instruction 304, also termed a “high instruction” herein, is executed to perform a lookup into the second lookup pair 204. As described herein, bit six of the index 210 is used to select either the third source register 120 or the fourth source register 122, and bits [5:0] of the index 210 are used to identify the byte lane within the selected source register. In at least one implementation, the bit seven value 312 functions as the selector line for the multiplexer 308 according to the second instruction 304. For example, second instruction 304 instructs the multiplexer 308 to overwrite the corresponding byte lane 208 of the index/destination register 114 with the result 206 of the lookup when the bit seven value 312 is “one” and to keep the original value 310 when the bit seven value 312 is “zero.”

By way of example, the inset 306 depicts the bit seven value 312 not applying a mask when executing the second instruction 304 so that the corresponding byte lane 208 is overwritten by the result 206. That is, the bit seven value 312 is “one,” and so, per the second instruction 304, the result 206 is selected via the multiplexer 308. As such, when the mask is applied while executing the first instruction 302, the mask is not applied while executing the second instruction 304, and vice versa. For example, as illustrated by comparing FIG. 3A and FIG. 3B, the byte lanes 208 that are masked while executing the first instruction 302 (and thus do not receive the result 206) are not masked while executing the second instruction 304 (and thus receive the result 206).

Additionally or alternatively, in at least one implementation, the first instruction 302 is used to perform the lookup when the bit seven value 312 is “zero,” and the second instruction 304 is used to perform the lookup when the bit seven value 312 is “one.” For example, a set value of “zero” in bit seven of the index 210 indicates that the entry having the desired result 206 is located in the first lookup pair 202. Because the first lookup pair 202 is defined in the first instruction 302 (and not the second instruction 304), the first instruction 302 is used when the bit seven value 312 is “zero” to retrieve the desired result 206, which is overwritten to the corresponding byte lane 208 of the index/destination register 114. As another example, a set value of “one” in bit seven of the index 210 indicates that the entry having the desired result 206 is located within the second lookup pair 204. Because the second lookup pair 204 is defined by the second instruction 304 (and not the first instruction 302), the second instruction 304 is used when the bit seven value 312 is “one” to retrieve the desired result 206, which is overwritten to the corresponding byte lane 208 of the index/destination register 114.

In this way, the non-limiting example implementation 300 enables an 8-bit input, 8-bit output using two instructions (e.g., the first instruction 302 and the second instruction 304) and without additional instructions to generate masks. By using the multiplexer 308 to select between the original value 310 and the result 206 of the lookup based on the bit seven value 312, the number of instructions used for performing the register-based lookups is decreased (e.g., in comparison to the non-limiting example implementation 200), which increases computing efficiency and performance (e.g., of the device 102).

Furthermore, the non-limiting example implementation 300 enables greater than eight bits of input to be used with decreased overhead. For example, permute instructions using the non-limiting example implementation 300 generate mask registers for each additional bit of input (e.g., greater than eight). In contrast, permute instructions using the non-limiting example implementation 200, for instance, generate mask registers for each additional bit of input in addition to generating the mask registers based on the bit seven value for performing the two lookups. As such, the non-limiting example implementation 300 uses fewer mask registers compared with the non-limiting example implementation 200.

In various implementations, a full 8-bit output is not desired when performing a lookup. For example, some applications, such as some finite-state machines, genomic data sequencing, and text parsing, are capable of utilizing a smaller lookup output. Thus, in accordance with the techniques described herein, a permute instruction that uses an 8-bit input for a 4-bit output is provided in order to make full use of the input index and to use fewer registers to store lookup tables.

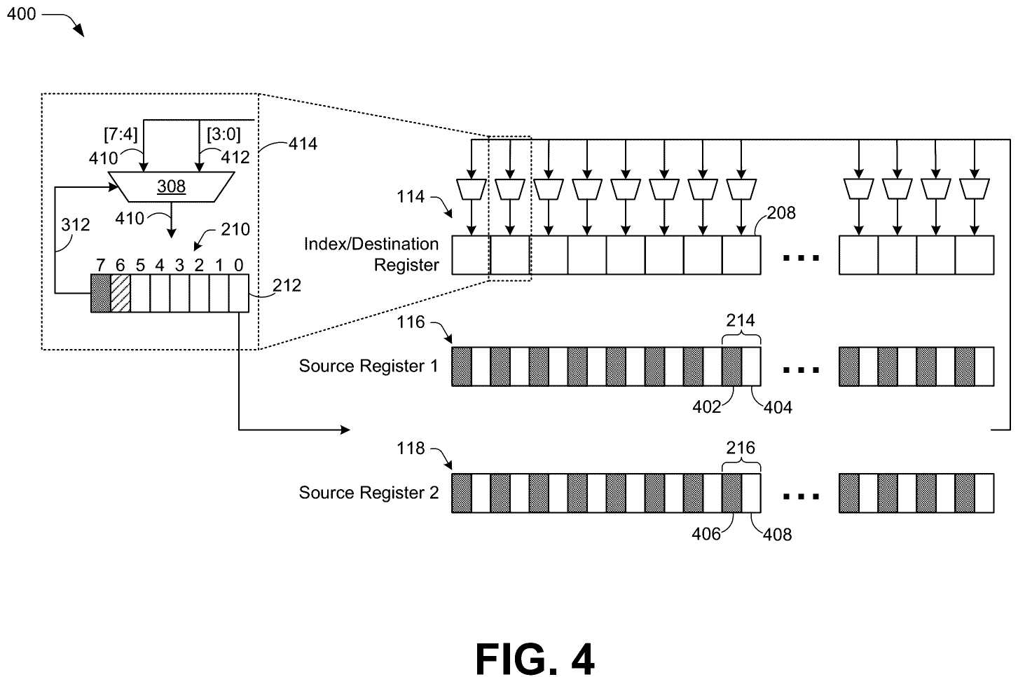

FIG. 4 shows a non-limiting example implementation 400 of a packed 4-bit permute instruction that is executed to perform an 8-bit input, 4-bit output register-based lookup. In the non-limiting example implementation 400, four lookup tables are stored in two registers. Although the first source register 116 and the second source register 118 are shown in the illustrated example, it is to be appreciated that in variations, other registers are accessed using the 4-bit permute instruction (e.g., the third source register 120 and the fourth source register 122). Each byte lane 214 of the first source register 116 is divided into high nibbles 402 and low nibbles 404, and each byte lane 216 of the second source register 118 is divided into high nibbles 406 and low nibbles 408. The high nibbles 402 and 406 include the four most significant bits in each byte lane (e.g., bits [7:4]), whereas the low nibbles 404 and 408 include the four least significant bits of each byte lane (e.g., bits [3:0]). As such, instead of four source registers defining 256 8-bit entries, two source registers define 256 4-bit entries. In at least one implementation, the high nibbles 402 of the first source register 116 define a first lookup table (e.g., entries 0-63), the high nibbles 406 of the second source register 118 define a second lookup table (e.g., entries 64-127), the low nibbles 404 of the first source register 116 define a third lookup table (e.g., entries 128-191), and the low nibbles 408 of the second source register 118 define a fourth lookup table (e.g., entries 192-255).

Similar to the non-limiting example implementation 200 of FIG. 2 and the non-limiting example implementation 300 of FIGS. 3A and 3B, bit six of the index 210 is used to select between the first source register 116 and the second source register 118, and bits [5:0] are used to identify the byte lane of the selected source register. Because each byte lane 214 and 216 includes two entries (e.g., the high nibble and the low nibble), the multiplexer 308 selects between a high nibble result 410 and a low nibble result 412 based on the bit seven value 312 of the index 210.

As depicted in an inset 414, the bit seven value 312 is used as the selector line of the multiplexer 308 to select one output from the two inputs (e.g., the high nibble result 410 and the low nibble result 412). The high nibble result 410 is selected in response to the bit seven value 312 indicating that the lookup result is defined in the high nibble half of the selected register (e.g., in the first lookup table when the first source register 116 is selected by the bit six value of the index 210 or the second lookup table when the second source register 118 is selected by the bit six value of the index 210). In contrast, the low nibble result 412 is selected in response to the bit seven value 312 indicating that the lookup result is defined in the low nibble half of the selected register (e.g., in the third lookup table when the first source register 116 is selected by the bit six value of the index 210 or the fourth lookup table when the second source register 118 is selected by the bit six value of the index 210). The high nibble result 410 is selected (e.g., by the multiplexer 308) when the bit seven value 312 is one of “zero” and “one,” and the low nibble result 412 is selected when the bit seven value 312 is the other of “zero” and “one.” In a non-limiting example, the first source register 116 is selected when bit six of the index 210 is “zero” and the high nibble result 410 is selected when the bit seven value 312 is “zero.” However, it is to be appreciated that the bit values may be assigned differently without departing from the spirit or scope of the described techniques. For example, alternatively, the first source register 116 is selected when bit six of the index is “one” and/or the high nibble result 410 is selected when the bit seven value 312 is “one.”

The selected result (e.g., the high nibble result 410 or the low nibble result 412) is written into the corresponding byte lane 208 of the index/destination register 114. In at least one implementation, the selected result is written into the least significant bits of the corresponding byte lane 208 (e.g., bits [3:0]) while the most significant bits (e.g., bits [7:4]) are zeroed out. In one or more variations, the selected result is written into the most significant bits of the corresponding byte lane 208 (e.g., bits [7:4]) while the least significant bits (e.g., bits [3:0]) are zeroed out. Alternatively, the bits not overwritten by the lookup retain their original values instead of being zeroed out. As such, each lookup outputs four bits of information into the index 210 using a single instruction.

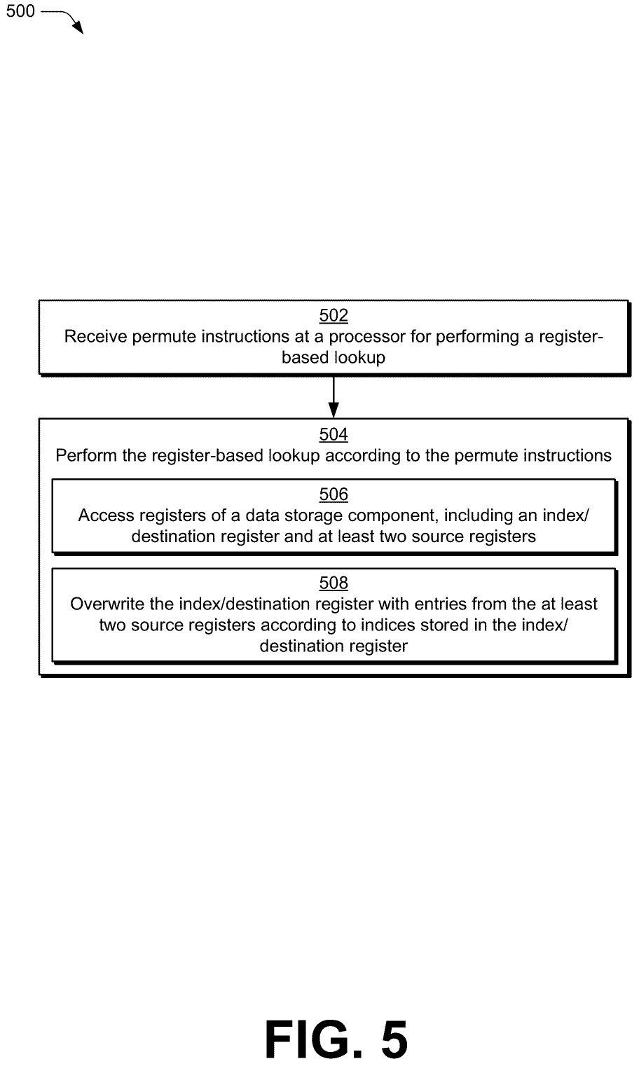

FIG. 5 depicts a procedure 500 in an example implementation of executing instructions by a processor (e.g., the processor 104) to perform a register-based lookup.

Permute instructions are received at the processor for performing the register-based lookup (block 502). By way of example, the permute instructions include a single instruction (e.g., the non-limiting example implementation 400) or multiple instructions (e.g., the first instruction 302 and the second instruction 304 of the non-limiting example implementation 300). In at least one implementation, the permute instructions are received from a compiler that translates source code into executable instructions.

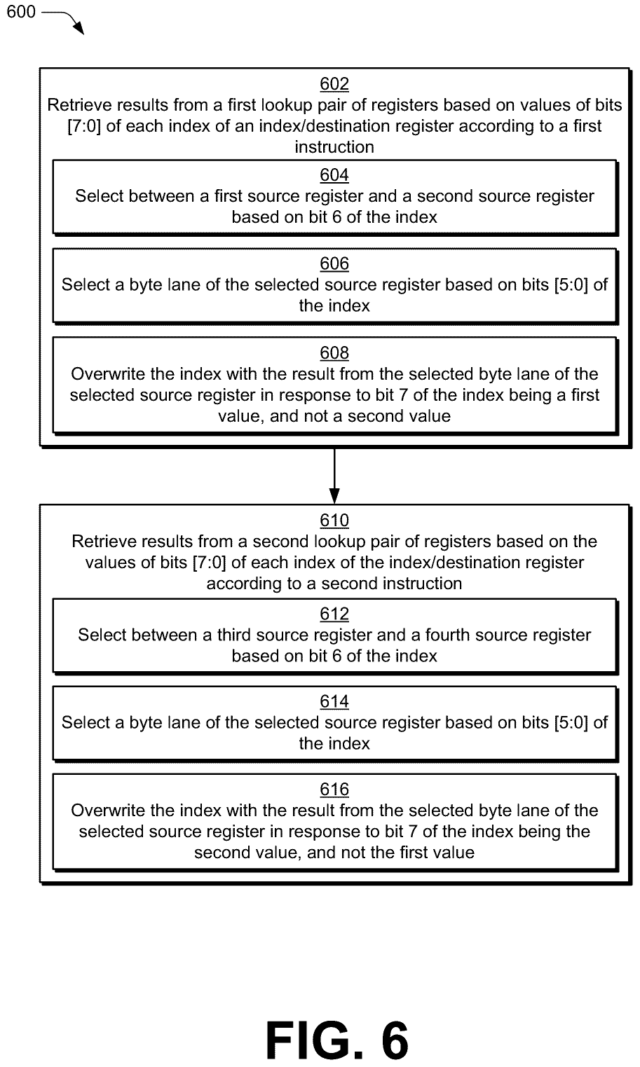

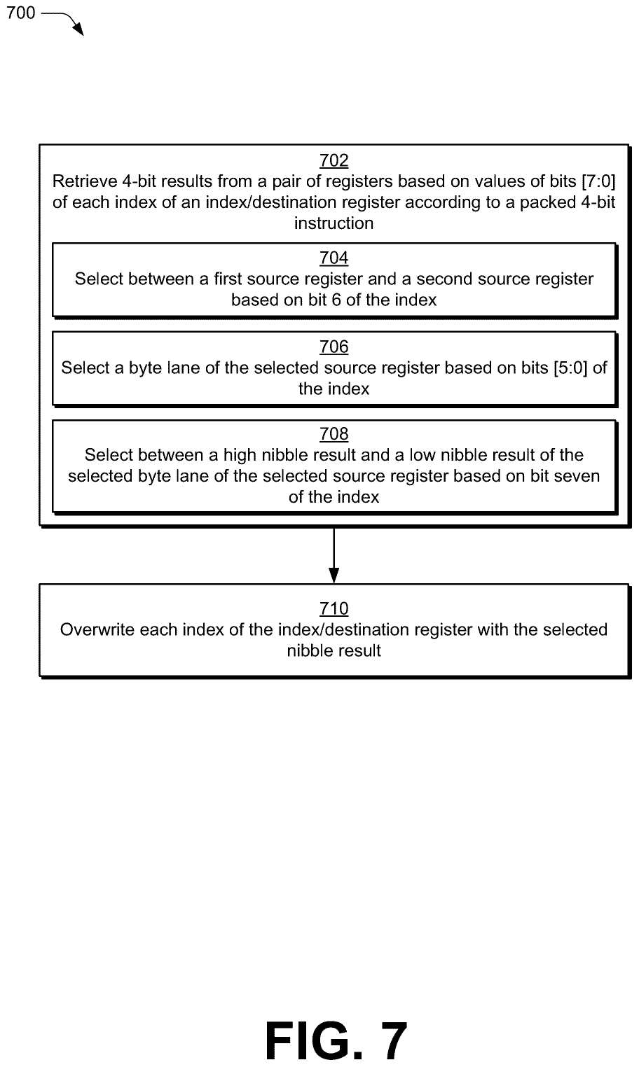

The register-based lookup is performed according to the permute instructions (block 504). In performing the register-based lookup, registers of a data storage component (e.g., data storage component 106), including the index/destination register (e.g., the index/destination register 114) and at least two source registers, are accessed (block 506). By way of example, the registers are accessed via an execution unit of the processor (e.g., the execution unit 108). Additionally, the index/destination register is overwritten with entries from the at least two source registers according to indices stored in the index/destination register (block 508). By way of example, a subset of bits (e.g., bits [6:0]) of each index of the index/destination register specify one byte lane of a number of different byte lanes stored in the at least two source registers, and each byte lane includes a single entry (e.g., when an 8-bit output is desired) or two entries (e.g., when a 4-bit output is desired). A given (e.g., specified) index is selectively overwritten with a given entry identified by the subset of bits based on a value of a bit of the given index that is excluded from the subset of bits (e.g., bit seven). Additional details regarding performing the register-based lookup according to the permute instructions are described herein, for example, with respect to FIGS. 6 and 7. For example, variations are provided for the 8-bit output (e.g., FIG. 6) and the 4-bit output (e.g., FIG. 7) that each utilize all eight bits of each index as input.

Thus, the permute instructions operate to fill the index/destination register with a specific combination of data values from at least two source registers (e.g., the first source register 116 and the second source register 118 and/or the third source register 120 and the fourth source register 122).

FIG. 6 depicts a procedure 600 in an example implementation of operations performed in a data storage component (e.g., the data storage component 106) while executing (e.g., by the processor 104) a register-based lookup.

Results are retrieved from a first lookup pair of registers based on values of bits [7:0] of each index of an index/destination register according to a first instruction (block 602). By way of example, the first lookup pair (e.g., the first lookup pair 202) includes a first source register (e.g., the first source register 116) and a second source register (e.g., the second source register 118) that each include half of the entries to be looked into using the first instruction. In one or more implementations, the first source register and the second source register each include 64 8-bit entries (e.g., 64 byte lanes).

According to the first instruction, the first source register and the second source register are selected between based on bit six of the index (block 604). By way of example, the first source register is selected when bit six of the index is set to “zero,” and the second source register is selected when bit six is set to “one.” Alternatively, the first source register is selected when bit six of the index is set to “one,” and the second source register is selected when bit six is set to “zero.” Thus, the binary nature of bit six enables either the first source register or the second source register to be selected.

According to the first instruction, a byte lane of the selected source register is selected based on bits [5:0] of the index (block 606). By way of example, the combination of values in bits [5:0] uniquely identify and select the byte lane of the selected source register that is to provide a result of the lookup. For example, because there are six bits in bits [5:0] and each bit is set to a “one” or a “zero,” there are 64 possible combinations of values, with each combination corresponding to a byte lane of the selected 64-byte source register.

According to the first instruction, the index is overwritten with the result from the selected byte lane of the selected source register in response to bit seven of the index being a first value, and not a second value (block 608). By way of example, the result from the selected byte lane is provided as a first input to a multiplexer (e.g., the multiplexer 308), which also receives the original value of the index as a second input. The multiplexer further receives the bit seven value as a select line for selecting between the first input and the second input. The multiplexer selects the result (e.g., the first input) in response to bit seven of the index being the first value and selects the original value of the index (e.g., the second input) in response to bit seven of the index being the second value. Additionally or alternatively, a mask is applied to the index, and thus the index is not overwritten, in response to the bit seven of the index being the second value. As a non-limiting example, the first value is zero and the second value is one. Alternatively, the first value is one and the second value is zero.

It is to be appreciated that in at least one variation, block 604 through block 608 is repeated for each index of the index/destination register while executing the first instruction.

Results are retrieved from a second lookup pair of registers based on the values of bits [7:0] of each index of the index/destination register according to a second instruction (block 610). By way of example, the second lookup pair (e.g., the second lookup pair 204) includes a third source register (e.g., the third source register 120) and a fourth source register (e.g., the fourth source register 122) that each include half of the entries to be looked into using the second instruction. Furthermore, the third source register and the fourth source register have the same number of byte lanes as the first source register and the second source register, at least in one implementation.

According to the second instruction, the third source register and the fourth source register are selected between based on bit six of the index (block 612). By way of example, the third source register is selected when bit six of the index is set to “zero,” and the fourth source register is selected when bit six is set to “one.” Alternatively, the third source register is selected when bit six of the index is set to “one,” and the fourth source register is selected when bit six is set to “zero.” Thus, the binary nature of bit six enables either the third source register or the fourth source register to be selected.

According to the second instruction, a byte lane of the selected source register is selected based on bits [5:0] of the index (block 614), including as described with respect to block 606.

According to the second instruction, the index is overwritten with the result from the selected byte lane of the selected source register in response to bit seven of the index being the second value, and not the first value (block 616). By way of example, the result from the selected byte lane is provided to the multiplexer as the first input, which also receives the original value of the index as the second input. Unlike the first instruction, while executing the second instruction, the multiplexer selects the result (e.g., the first input) in response to bit seven of the index being the second value and selects the original value of the index (e.g., the second input) in response to bit seven of the index being the first value. Additionally or alternatively, a mask is applied to the index, and thus the index is not overwritten, in response to the bit seven of the index being the first value.

It is to be appreciated that in at least one variation, block 612 through block 616 is repeated for each index of the index/destination register while executing the second instruction. In this way, two permute instructions (e.g., the first instruction and the second instruction) are executed to combine results from four source registers in the index/destination register in for an 8-bit input, 8-bit output.

FIG. 7 depicts a procedure 700 in an example implementation of operations performed in a data storage component (e.g., the data storage component 106) while executing (e.g., by the processor 104) a packed 4-bit permute.

Four-bit results are retrieved from a pair of registers based on values of bits [7:0] of each index of an index/destination register according to a packed 4-bit instruction (block 702). By way of example, the pair of registers includes a first source register (e.g., the first source register 116) and a second source register (e.g., the second source register 118) that each include half of the entries to be looked into. In one or more implementations, the first source register and the second source register each include 8-bit entries (e.g., byte lanes) that are sub-divided into low nibbles (e.g., bits [3:0]) and high nibbles (e.g., bits [7:4]). In a non-limiting example, the first source register and the second source register each include 64 byte lanes (e.g., 128 4-bit entries).

According to the packed 4-bit instruction, the first source register and the second source register are selected between based on bit six of the index (block 704). By way of example, the first source register is selected when bit six of the index is set to “zero,” and the second source register is selected when bit six is set to “one.” Alternatively, the first source register is selected when bit six of the index is set to “one,” and the second source register is selected when bit six is set to “zero.” Thus, the binary nature of bit six enables either the first source register or the second source register to be selected.

According to the packed 4-bit instruction, a byte lane of the selected source register is selected based on bits [5:0] of the index (block 706). By way of example, the combination of values in bits [5:0] uniquely identify and select the byte lane of the selected source register that is to provide results of the lookup. For example, because there are six bits in bits [5:0] and each bit is set to a “one” or a “zero,” there are 64 possible combinations of values, with each combination corresponding to a byte lane of the selected 64-byte source register. The selected byte lane includes a high nibble result and a low nibble result.

According to the packed 4-bit instruction, the high nibble result and the low nibble result are selected between based on bit seven of the index (block 708). By way of example, the high nibble result from the selected byte lane is provided as a first input to a multiplexer (e.g., the multiplexer 308), and the low nibble result from the selected byte lane is provided as a second input to the multiplexer. The multiplexer further receives the bit seven value as a select line for selecting between the first input and the second input. The multiplexer selects the high nibble result (e.g., the first input) in response to bit seven of the index being a first value and selects the low nibble result (e.g., the second input) in response to bit seven of the index being a second value. As a non-limiting example, the first value is zero and the second value is one. Alternatively, the first value is one and the second value is zero.

It is to be appreciated that in at least one variation, block 704 through block 708 is repeated for each index of the index/destination register while executing the packed 4-bit instruction.

Each index of the index/destination register is overwritten with the selected nibble result (block 710). By way of example, the selected nibble result is written into the least significant bits (e.g., bits [3:0]), and the most significant bits (e.g., bits [7:4]) are set to 0. In this way, a 4-bit output is provided for an 8-bit input with reduced instructions and without additional masking overhead.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, the processor 104, the data storage component 106, the execution unit 108, the memory controller 110, and the registers 112) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

In the preceding description, the use of the same reference numerals in different drawings indicates similar or identical items.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A system comprising:
a destination register and at least two source registers storing lookup tables; and
a processor configured to perform a register-based lookup by:
retrieving a first result from a first lookup table based on a subset of bits included in an index of the destination register;
retrieving a second result from a second lookup table based on the subset of bits included in the index of the destination register;
selecting the first result or the second result based on a bit in the index of the destination register that is excluded from the subset of bits; and
overwriting data included in the index of the destination register using a selected one of the first result or the second result.

2. (canceled)

3. The system of claim 1, wherein the index of the destination register includes a byte lane of eight bits, and wherein overwriting the data included in the index of the destination register comprises:
overwriting the byte lane with the first result in response to the bit in the index of the destination register that is excluded from the subset of bits including a first value; or
overwriting the byte lane with the second result in response to the bit in the index of the destination register that is excluded from the subset of bits including a second value.

4. The system of claim 1, wherein selecting the first result or the second result comprises:
inputting the first result and the second result to a multiplexer;
providing the bit in the index of the destination register that is excluded from the subset of bits as a select line to the multiplexer; and
causing the multiplexer to output the first result in response to the bit in the index of the destination register that is excluded from the subset of bits being a first value; or
causing the multiplexer to output the second result in response to the bit in the index of the destination register that is excluded from the subset of bits being a second value.

5. The system of claim 1, wherein the retrieving the first result from the first lookup table and retrieving the second result from the second lookup table comprises retrieving the first result by executing a first instruction and retrieving the second result by executing a second instruction.

6. The system of claim 5, wherein retrieving the first result from the first lookup table by executing the first instruction and retrieving the second result from the second lookup table by executing the second instruction comprises:
while executing the first instruction:
selecting, as the first lookup table, a first source register or a second source register from the at least two source registers based on one of the subset of bits included in the index of the destination register;
selecting a first byte lane of the selected first source register or the selected second source register based on a remainder the subset of bits included in the index of the destination register, the remainder excluding the one; and
retrieving the first result from the first byte lane; and
while executing the second instruction:
selecting, as the second lookup table, a third source register or a fourth source register from the at least two source registers based on the one of the subset of bits included in the index of the destination register;
selecting a second byte lane of the selected third source register or the selected fourth source register based on the remainder of the subset of bits included in the index of the destination register; and
retrieving the second result from the second byte lane.

7. The system of claim 6, wherein the subset of bits included in the index of the destination register includes bits [6:0] of an eight-bit index, wherein:
the one of the subset of bits is bit six of the eight-bit index; and
the remainder of the subset of bits include bits [5:0] of the eight-bit index.

8. The system of claim 6, wherein the index of the destination register includes an eight-bit index, and wherein overwriting the data included in the index of the destination register using the selected one of the first result or the second result comprises:
overwriting the data included in the index of the destination register with the first result in response to bit seven of the eight-bit index being a first value while executing the first instruction; or
overwriting the data included in the index of the destination register with the second result in response to the bit seven of the eight-bit index being a second value while executing the second instruction.

9. The system of claim 8, wherein overwriting the data included in the index of the destination register using the selected one of the first result or the second result further comprises:
while executing the first instruction:
providing the first result and an original value of the eight-bit index as inputs to a multiplexer;
providing the bit seven as a select line to the multiplexer; and
receiving the first result as an output of the multiplexer in response to the bit seven being the first value; or
receiving the original value as the output of the multiplexer in response to the bit seven being the second value; and
while executing the second instruction:
providing the second result and the original value of the eight-bit index as inputs to the multiplexer;
providing the bit seven as the select line to the multiplexer; and
receiving the second result as the output of the multiplexer in response to the bit seven being the second value; or
receiving the original value as the output of the multiplexer in response to the bit seven being the first value.

10. A system comprising:
a destination register storing indices and at least two source registers storing lookup tables; and
a processor configured to execute instructions to:
access the destination register and the at least two source registers; and
for an index of the destination register:
identify a byte lane of the at least two source registers based on bits [6:0] of the index of the destination register; and
overwrite data included in the index of the destination register with a lookup entry defined in the identified byte lane based on a value of bit seven of the index of the destination register.

11. The system of claim 10, further comprising a multiplexer positioned in a data path between the at least two source registers and the index of the destination register, the multiplexer configured to:
receive two inputs and a select line; and
output one of the two inputs based on the select line.

12-14. (canceled)

15. The system of claim 11, wherein to overwrite the data included in the index of the destination register, the processor is further configured to execute the instructions to:
provide the lookup entry to the multiplexer as a first input of the two inputs;
provide an original value of the index of the destination register to the multiplexer as a second input of the two inputs;
provide the value of bit seven as the select line to the multiplexer; and
overwrite the data included in the index of the destination register with an output of the multiplexer.

16. The system of claim 15, wherein the lookup entry includes a first lookup entry retrieved while executing a first instruction of the instructions and a second lookup entry retrieved while executing a second instruction of the instructions, and wherein the processor is configured to execute the first instruction and the second instruction in combination.

17. The system of claim 16, wherein, to overwrite the data included in the index of the destination register, the processor is further configured to execute the instructions to:
during the first instruction:
select the first lookup entry as the output of the multiplexer in response to the value of bit seven being a first value; and
select the original value of the index of the destination register as the output of the multiplexer in response to the value of bit seven being a second value; and
during the second instruction:
select the second lookup entry as the output of the multiplexer in response to the value of bit seven being the second value; and
select the original value of the index of the destination register as the output of the multiplexer in response to the value of bit seven being the first value.

18. The system of claim 16, wherein to execute the first instruction and the second instruction in combination, the processor is further configured to:
identify the byte lane from a first lookup pair that includes a first source register and a second source register of the at least two source registers while executing the first instruction; and
identify the byte lane from a second lookup pair that includes a third source register and a fourth source register of the at least two source registers while executing the second instruction.

19. A method comprising:
accessing a destination register and a plurality of source registers, the destination register storing indices for retrieving a combination of entries from the plurality of source registers; and
for at least one of the indices of the destination register:
retrieving a first entry identified by bits [6:0] of an index in the destination register from a first lookup table that is stored in the plurality of source registers;
retrieving a second entry identified by the bits [6:0] of the index in the destination register from a second lookup table that is stored in the plurality of source registers; and
overwriting data included in the index in the destination register with the first entry or the second entry based on a value of bit seven of the index in the destination register.

20. The method of claim 19, further comprising:
providing the first entry and the second entry as inputs to a multiplexer and providing the value of bit seven of the index in the destination register as a select line to the multiplexer; and
selecting the first entry or the second entry for overwriting the data included in the index in the destination register based on an output of the multiplexer.

21. The method of claim 19, wherein overwriting the data included in the index in the destination register with the first entry or the second entry based on the value of bit seven of the index in the destination register comprises:
overwriting the data included in the index in the destination register with the first entry in response to the value of bit seven of the index in the destination register being a first value; or
overwriting the data included in the index in the destination register with the second entry in response to the value of bit seven of the index in the destination register being a second value.

22. The method of claim 19, wherein overwriting the data included in the index in the destination register with the first entry or the second entry based on the value of bit seven of the index in the destination register comprises:
inputting the first entry and the second entry to a multiplexer;
providing the value of bit seven of the index in the destination register as a select line to the multiplexer;
causing the multiplexer to output the first entry in response to the value of bit seven of the index being a first value;
causing the multiplexer to output the second entry in response to the value of bit seven of the index being a second value; and
overwriting the data included in the index in the destination register based on an output of the multiplexer.

23. The method of claim 19, wherein retrieving the first entry identified by bits [6:0] of the index in the destination register from the first lookup table that is stored in the plurality of source registers comprises:
selecting, as the first lookup table, a first source register or a second source register of the plurality of source registers based a value of bit six of the index in the destination register;
selecting a first byte lane of the first lookup table based on bits [5:0] of the index in the destination register; and
retrieving the first entry from the first byte lane.

24. The method of claim 23, wherein retrieving the second entry identified by the bits [6:0] of the index in the destination register from the second lookup table that is stored in the plurality of source registers comprises:
selecting, as the second lookup table, a third source register or a fourth source register of the plurality of source registers based on the value of bit six of the index in the destination register;
selecting a second byte lane of the second lookup table based on the bits [5:0] of the index in the destination register; and
retrieving the second entry from the second byte lane.
